(19) United States
(12) Patent Application Publication
(10) Pub. No.: US 2025/0146885 A1
(43) Pub. Date: May 8, 2025

(54) Auto Detection of Cold Junction Compensation in a Temperature Module

(71) Applicant: Rockwell Automation Asia Pacific Business Center, Pte. Ltd., Singapore (SG)

(72) Inventors: Chia Leong Chin, Singapore (SG); Rajesh Ramesh Shah, Singapore (SG); Chee Haw Lee, Singapore (SG)

(21) Appl. No.: 19/018,517

(22) Filed: Jan. 13, 2025

Related U.S. Application Data
(63) Continuation-in-part of application No. 18/201,152, filed on May 23, 2023.

(51) Int. Cl. G01K 7/02

(52) U.S. Cl. CPC G01K 7/021; G01K 2219/00

(57) ABSTRACT

An I/O module configured to automatically detect a cold junction compensation (CJC) sensor includes a base and a removable terminal block (RTB). The RTB includes multiple terminals. An I/O circuit mounted within the base includes multiple contact pairs, where a first contact is mounted in the RTB and electrically connected to one of the terminals and a second contact is mounted in the base and electrically connected to the I/O circuit. A CJC sensor is mounted within the base proximate one of the second contacts and is operative to generate a feedback signal corresponding to a temperature present at the second contact. A controller in the I/O circuit generates a control signal to selectively connect the CJC sensor to an electrical ground connection. A switch connected between the CJC sensor and the electrical ground connection receives the control signal to selectively connect the CJC sensor to the electrical ground connection.

### CROSS-REFERENCE TO RELATED APPLICATIONS

This application is a continuation-in-part of and claims priority to U.S. application Ser. No. 18/201,152, filed May 23, 2023, the entire contents of which is incorporated herein by reference.

### BACKGROUND INFORMATION

The subject matter disclosed herein relates to temperature input/output (I/O) modules for industrial control systems. More specifically, a temperature I/O module includes at least one cold junction compensation (CJC) sensor and is able to automatically detect which CJC sensor is present in the temperature I/O module.

Temperature input/output (I/O) modules for industrial control systems often receive analog temperature input signals from remote temperature sensors and convert the received temperature signals to digital signals used by an industrial control system to monitor and control the system or process. The remote temperature sensor can be an RTD (Resistance Temperature Detector) sensor or can be a thermocouple temperature sensor. A thermocouple comprises two electrical conductors that are dissimilar metals. The two conductors are joined at one end, referred to as the hot junction because it is located where the temperature is to be sensed in or adjacent an industrial process or system. The two opposite free ends of the conductors are joined to respective terminals (referred to as the cold junction) of a removable terminal block (RTB) and the voltage differential between the free ends is sensed. When using a thermocouple, the temperature of this cold junction must be known to compensate for a thermoelectric voltage that is generated when the cold junction is at a temperature other than zero degrees Celsius (0° C.) due to the connection between the thermocouple conductors and the copper or other conductors to which the thermocouple conductors are connected.

Although an RTD can be highly accurate, stable, and can provide a linear response, the use of a thermocouple instead of an RTD can be desirable for many reasons including lower cost, faster response, a higher temperature range, and higher durability in harsh conditions often associated with complex industrial systems. As noted above, however, a thermocouple requires cold junction compensation which has heretofore been accomplished by locating a CJC temperature sensor such as a thermistor or other temperature sensor (sometimes referred to herein generally as a “CJC sensor”) on or within the removable terminal block (RTB), either by connecting the CJC sensor externally between first and second terminals of the RTB or by permanently embedding the CJC sensor within the molded polymer or other structure of the RTB. When the RTB is separated from a base of the I/O module, the CJC sensor moves with the RTB and is thus also separated from the I/O module base.

In either case, whether the CJC sensor is connected externally to the terminals of the RTB or embedded within the RTB, the functionality of the RTB is reduced because at least two of the RTB terminals are dedicated to the CJC sensor or are eliminated to provide space for the CJC sensor and its connections. Furthermore, an RTB can sometimes include two spaced-apart CJC sensors to allow for the fact that temperature can vary between first and second locations of the RTB, in which case the conductors of two different thermocouples are connected to the RTB adjacent respective first and second CJC sensors to ensure that the sensed CJC temperature is accurate for each thermocouple. As such, external or embedded CJC sensor(s) limit the functionality of the RTB by reducing the availability of RTB terminals for other I/O connections. Furthermore, CJC sensor(s) connected to or embedded in an RTB require use of two contact pairs of the RTB and I/O module that operatively connect the RTB to the I/O module when the RTB is physically and electrically mated with the I/O module. Also, an RTB with one or more embedded CJC sensors must be specially manufactured and stocked, which increases costs for the manufacturer, distributor, and customer. Similarly, the use of an external CJC sensor that is connected to the RTB requires that the CJC sensor be supplied and connected during manufacture or in the field, which can increase the cost and complexity of supply and installation.

Thus, it would be desirable to provide a CJC sensor within the I/O module which does not reduce the number of terminals available for connection to external devices.

As is known to those skilled in the art, however, some applications may still require the accuracy and performance of the CJC sensor embedded within the RTB. Therefore, it would further be desirable to provide a temperature I/O module capable of utilizing either a CJC sensor within the I/O module which does not reduce the number of terminals available for connection to external devices or a CJC sensor embedded within the RTB.

### BRIEF DESCRIPTION

According to one embodiment of the invention, an I/O module includes a base and a removable terminal block selectively connected to the base, where the RTB includes multiple terminals. An I/O circuit is mounted within the base. The I/O module also includes multiple contact pairs, where each contact pair includes a first contact mounted in the RTB and electrically connected to one of the terminals, and each contact pair includes a second contact mounted in the base and electrically connected to the I/O circuit. A first cold junction compensation (CJC) sensor is mounted within the base proximate the second contact from one of the contact pairs and is operative to generate a first feedback signal corresponding to a temperature present at the second contact. A switch is connected between the first CJC sensor and an electrical ground connection to selectively connect the first CJC sensor to the electrical ground connection.

According to another embodiment of the invention an I/O module includes a base configured to selectively receive either a first RTB or a second RTB, an I/O circuit mounted within the base, and multiple first contacts mounted within the base and electrically connected to the I/O circuit. A first CJC sensor is mounted within the base proximate one of the first contacts and operative to generate a first feedback signal corresponding to a temperature present at the corresponding first contact. A controller in the I/O circuit is operative to generate a control signal to selectively connect the first CJC sensor to an electrical ground connection, and a switch is connected between the first CJC sensor and the electrical ground connection. The switch receives the control signal to selectively connect the first CJC sensor to the electrical ground connection.

According to still another embodiment of the invention, a method of detecting a CJC sensor in an I/O module includes providing a first CJC sensor proximate a second contact from a contact pair. A first contact of the contact pair is mounted in a RTB for the I/O module, and the first contact is electrically connected to a terminal for the RTB. The second contact is mounted in a base for the I/O module, and the second contact is electrically connected to an I/O circuit mounted in the base. A first feedback signal is generated with the first CJC, where the first feedback signal corresponds to a temperature present at the second contact. The first CJC is selectively connected to an electrical ground connection with a switch. A first value of the first feedback signal is detected with an analog-to digital (A/D) converter, where the first value corresponds to the first CJC being present in the base of the I/O module and the switch being closed to connect the first CJC to the electrical ground connection.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 (prior art) illustrates one example of a known industrial control system 110 for controlling a controlled system 140.

FIG. 2 (prior art) shows an input/output (I/O) module including a removable terminal block (RTB), wherein the RTB includes at least one embedded CJC sensor (shown as first and second embedded CJC sensors) for cold junction compensation.

FIG. 3 (prior art) is a side view of the I/O module of FIG. 2.

FIG. 4 (prior art) is a diagrammatic illustration of an I/O module such as that shown in FIGS. 2 & 3 including at least one CJC sensor embedded in the removable terminal block (only one embedded CJC sensor is shown to simplify the drawing).

FIG. 5 is a diagrammatic illustration of an I/O module provided in accordance with an embodiment of the present development including at least one CJC sensor located within the I/O module, itself, instead of being embedded in the removable terminal block (first and second CJC sensors are shown in the illustrated example).

FIG. 6 is a diagrammatic illustration of an I/O module provided in accordance with another embodiment of the present development including at least one CJC sensor located within the I/O module and at least one CJC sensor embedded in the removable terminal block. A switch is provided in the base for autodetection of the presence of the at least one CJC sensor embedded in the removable terminal block.

FIG. 7 is a simplified block diagram of the switch provided in the base for autodetection of the presence of the at least one CJC sensor embedded in the removable terminal block I/O module of FIG. 6.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art

### DETAILED DESCRIPTION

The various features and advantageous details of the subject matter disclosed herein are explained more fully with reference to the non-limiting embodiments described in detail in the following description.

The subject matter disclosed herein describes a temperature I/O module which includes a cold junction compensation (CJC) sensor within a body of the I/O module such that the CJC sensor does not require passing signals between the removable terminal block (RTB) and the base. Because contacts between the RTB and the base are not required for a feedback signal from the CJC, the CJC sensor positioned within the body of the I/O module will not reduce the number of terminals available for connection to external devices. According to another feature of the invention, the I/O module base is configured to accept different RTBs. One RTB may be fully populated with terminals for connection to external devices to maximize the number of external connections available. Another application may still require a CJC sensor embedded within the RTB to achieve a desired performance. The I/O module base may, therefore, also accept an RTB with an embedded CJC. The I/O module base is further configured to automatically detect the presence of an embedded CJC within the RTB and to utilize the feedback signal from the CJC in the RTB rather than a feedback signal generated by a CJC within the base of the I/O module to compensate a temperature feedback signal received from a thermocouple connected to the RTB.

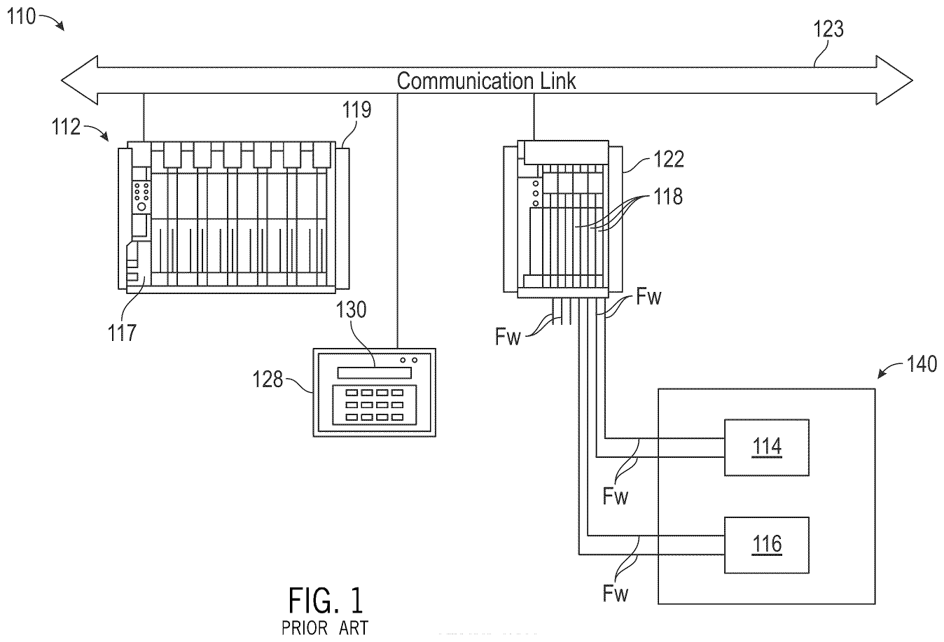

FIG. 1 illustrates one example of a known industrial control system 110 for controlling a controlled system 140. The illustrated and described industrial control system 110 and controlled system 140 are merely examples and other industrial control systems and controlled systems 140 are contemplated as part of the present disclosure. The terms “system” and “controlled system” can mean any device or machine or group of devices or machines, a process or a series of processes, or a combination of one or more devices, machines, and/or processes.

The industrial control system 110 comprises a programmable control system or “controller” 112 that controls the output status of one or a plurality of output devices 116 associated with the controlled system 140 based on the input status of one or a plurality of input devices 114 associated with the controlled system. To this end, the controller 112 includes a microprocessor-based processor or processor module 117 that executes a stored control program that defines the manner in which the output devices 116 are controlled based upon input received from the input devices 114.

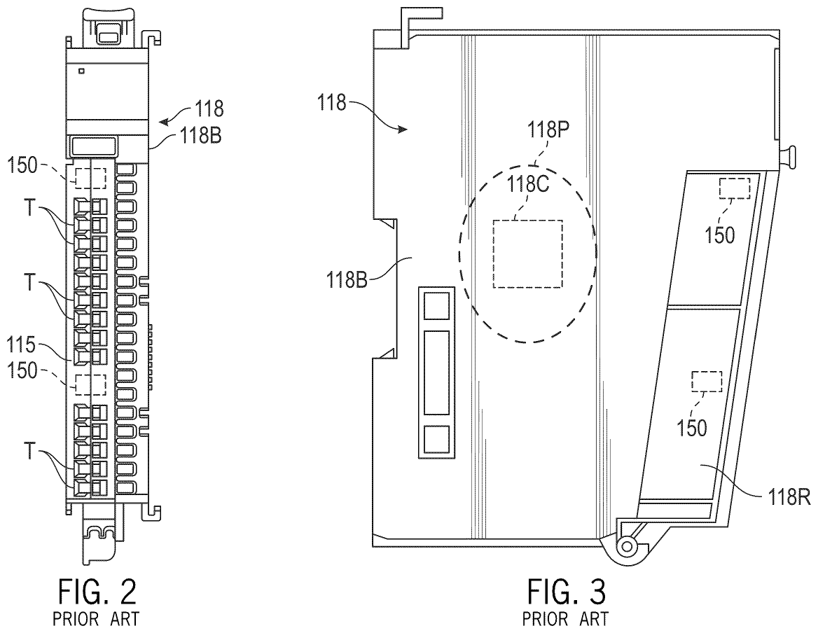

The processor module 117 communicates with the input and output devices 114,116 through one or more input/output modules or “I/O modules” 118. With reference also to FIGS. 2-4, the input and output devices 114,116 are each operably connected to an I/O module 118 using field wiring FW connected to the I/O module input or output channels through the terminals T (FIGS. 2, 3, 4) of a terminal block which can be a removable terminal block (RTB) 118R that can be selectively separated from the I/O module base 118B. The processor module 117 transmits a digital representation of the desired operational status of an output device 116 to the I/O module 118 connected to the particular output device 116.

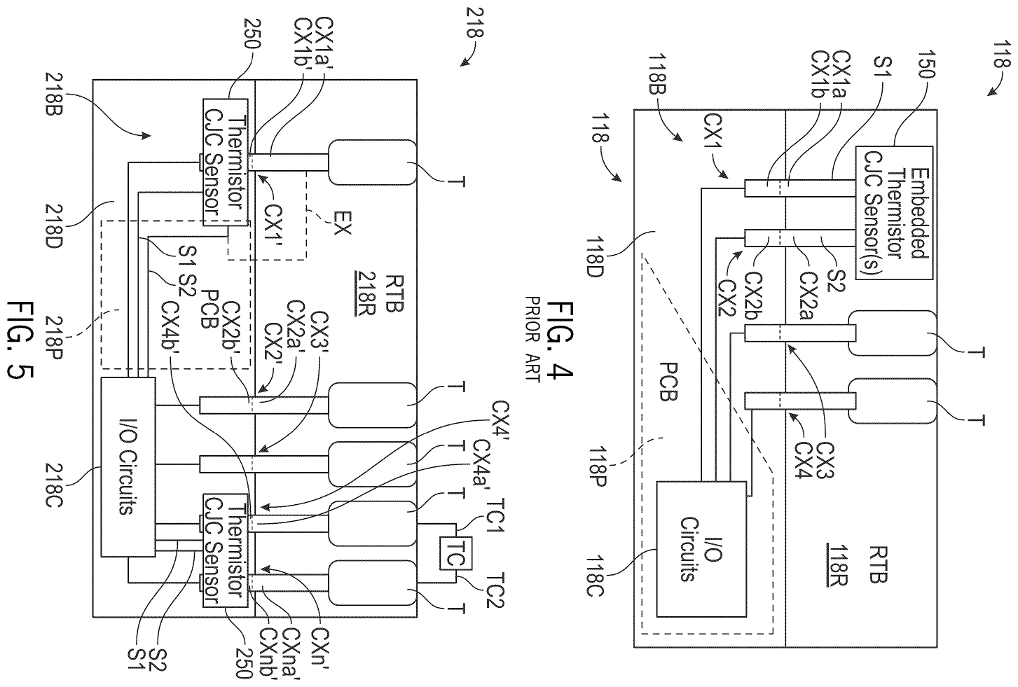

As shown in FIG. 4, the I/O module base 118B includes or contains one or more printed circuit board assemblies (PCB) 118P that are connected to a body 118D of the I/O module base 118B and that comprise an electronic I/O circuit or I/O circuitry 118C including an analog-to-digital converter (ADC), a digital to analog converter (DAC), and/or other I/O circuitry for facilitating input from the input devices 114 and output to the output devices 116. Based on the digital representation of the desired operational status of the output device 116, the I/O circuit 118C produces and outputs an output control signal that is capable of driving or controlling the output device 116 in the desired manner as instructed by the processor module 117. Likewise, the processor module 117 receives a digital representation of the operational status of an input device 114 from the I/O module 118 that is connected to the particular input device 114. The I/O circuit 118C produces and outputs a digital data representation of the operational status of the input device 114 based on input status signals received from the input device 114 and communicates the digital data representation to the processor module 117.

The I/O circuit 118C includes a controller 334 operable to receive control signals from the processor module 117 and to generate control signals for use within the I/O module 118. The controller 334 may include a microcontroller, a microprocessor, a field programmable gate array (FPGA), an application specific integrated circuit (ASIC), function specific co-processors, digital logic circuits, and the like. According to one aspect of the invention, the controller 334 for the I/O circuit 118C includes a memory device and a processor. The memory device may a single device or multiple devices include non-transitory memory. Instructions are stored in the memory device and are executable by the processor. The processor may be a single processor, multiple processor executing in parallel, or multiple processing devices configured to execute specific functions. For example, a first processing device may be configured to manage communication by the I/O module 118 on the industrial network 123. The communication processing device may send and receive data packets with the processor module 117 or other devices connected to the industrial network 123. A second processing device may be configured to manage I/O tables stored in the memory device. Digital representation of data received from input devices 114 may stored in the I/O table for subsequent transmission to the processor module 117. Desired output signals may be received from the processor module 117, stored in the I/O table, and subsequently output on each output channel. According to another aspect of the invention, the I/O circuit 118C may include logic circuits configured to pass data between input and output channels and the industrial network, where the processor module 117 performs processing on the digital representations of data. It is contemplated that the reception, storage, and management of the I/O data may be assigned to either the processor module 117, the I/O module 118, or a combination thereof according to an application's requirements.

Those of ordinary skill in the art will recognize that the term “I/O module” is a general term that refers to input modules that receive input from one or more of the input devices 114, output modules that provide output to one or more of the output devices 116, and combined input and output modules that both receive input from one or more of the input devices 114 and also provide output to one or more of the output devices 116.

In the illustrated embodiment, the processor module 117 is disposed in a first or controller installation 119 which can be a first cabinet, rack, chassis, and/or modular assembly and the I/O module 118 is disposed in a separate second or I/O installation 122 which can be a second cabinet, rack, chassis, or modular assembly that can be adjacent the controller installation 119 or remote from the controller installation 119 (as shown). Communication between the processor module 117 and the I/O module(s) 118 occurs by way of a wired and/or wireless network or other communication link 123 such as an industrial ethernet network or another network. The industrial control system 110 also comprises other features such as an operator interface 128 and a message display 130.

In the known system of FIGS. 1-4, at least one of the input devices 114 is provided as an analog temperature sensor input device such as a thermocouple that requires cold junction compensation (CJC). As such, at least one of the I/O modules 118 is provided and/or configured as a temperature input module comprising a removable terminal block RTB (FIGS. 2-4) including at least one CJC sensor 150 that is embedded in or otherwise connected to the polymeric body of the removable terminal block 118R. In FIG. 4, the removable terminal block 118R is shown as comprising at least one CJC sensor 150. Typically, at least two spaced-apart CJC sensors 150 are embedded in the removable terminal block 118R, for example at opposite vertical ends when the removable terminal block 118R is vertically oriented, to sense and account for thermal variations in the operating environment of the I/O module 118. As is readily apparent in FIGS. 2 & 3, known systems that embed one or more CJC sensors 150 in the removable terminal block RTB include a reduced number of field wiring connection terminals T due to the space utilized by the one or more CJC sensors 150 and their related conductors, i.e., physical space in the body of the removable terminal block 118R that could otherwise be occupied by a field wiring connection terminal T and its conductor(s) is occupied by the CJC sensor 150 and its associated conductors, which reduces the terminals T available for the field wiring FW. When the removable terminal block 118R is physically separated from the I/O module base 118B, the embedded CJC sensors 150 move with the removable terminal block 118R since they are embedded in or otherwise connected to the removable terminal block 118R. As such, as shown in FIG. 4, when one or more CJC sensors 150 are embedded in the body of a removable terminal block 118R, first and second conductors S1,S2 of the CJC sensor 150 must be electrically connected to the I/O circuitry 118C of the I/O module base 118B respectively through a first contact pair CX1 (for the first CJC sensor conductor S1) and a second contact pair CX2 (for the second CJC sensor conductor S2), wherein the first constituent contact CX1a, CX2a of each of contact pair CX1,CX2 is operably connected to one of the sensor conductors S1,S2 within the removable terminal block 118R and the second constituent contact CX1b, CX2b of each of the first and second contact pairs CX1,CX2 is connected to the I/O module base printed circuit board 118P and operably connected to the I/O circuitry 118C. Since these first and second contact pairs CX1, CX2 are used for the CJC sensor conductors S1,S2, they are unavailable to be used as contact pairs for transferring data or signals related to the controlled system 140 between the terminals T of the removable terminal block RTB and the I/O circuitry 118C (see contact pairs CX3,CX4 connected to the terminals T).

An I/O module 218 as shown in FIG. 5 is provided in accordance with an embodiment of the present development and overcomes the above-noted deficiencies and others associated with known I/O modules 118. Except as otherwise shown and/or described herein, the I/O module 218 is identical to the I/O module 118, and like components and features are identified with reference numbers that are 100 greater than those used in FIGS. 1-4 or are identified with a prime (′) designation in some cases. As with the known I/O module 118, the input and output devices 114,116 of a controlled system 140 can be operably connected to an I/O module 218 formed in accordance with the present development using field wiring FW connected to the I/O module input or output channels through the terminals T of a terminal block which can be a removable terminal block (RTB) 218R that can be selectively separated from an I/O module base 218B. The I/O module base 218B includes a body 218D. As with the known I/O module 118, the processor module 117 of system 110 transmits a digital representation of the desired operational status of an output device 116 to the I/O module 218 that is connected to the output device 116. Each terminal T of the removable terminal block 218R is operably electrically connected to the I/O circuit 218C of the I/O module base 218B through a terminal block contact pair CX1′, CX2′, . . . . CXn′ (generally CXn′) each comprising a respective first constituent contact CX1a′, CX2a′, . . . , CXna′ (generally CXna′) operably connected to the terminal T of the removable terminal block RTB and a respective second constituent contact CX1b′, CX2b′, . . . , CXnb′ (generally CXnb′) operably connected to the printed circuit board assembly 218P of the I/O module base 218B. The respective first and second constituent contacts CXna′, CXnb′ mate to form the terminal block contact pair CXn′ when the removable terminal block 218R is physically operably connected to the I/O module base 218B such that the terminal T is operably electrically connected to the I/O circuit 218C through the printed circuit board assembly 218P. In this sense, the I/O module 218 comprises a plurality of contact pairs CXn′ each including: (i) a first constituent contact CXna′ connected to the removable terminal block 218R and electrically connected to one of said terminals T; (ii) a second constituent contact CXnb′ connected to said I/O base 218B and electrically connected to said I/O circuitry 218C.

With continuing reference to FIG. 5, the I/O module base 218B includes one or more printed circuit board assemblies 218P located in or otherwise connected to the body 218D. The one or more printed circuit board assemblies 218C comprise an electronic I/O circuit or I/O circuitry 218C including an analog-to-digital converter (ADC), a digital to analog converter (DAC), and/or other I/O circuitry for facilitating input from the input devices 114 and output to the output devices 116. Based on the digital representation of the desired operational status of the output device 116 as received from the processor module 117, the I/O circuit 218C produces and outputs an output control signal that is capable of driving or controlling the output device 116 in the desired manner as instructed by the processor module 117. Likewise, the processor module 117 receives a digital representation of the operational status of an input device 114 from the I/O module 218 that is connected to the input device 114. In particular, the I/O circuit 218C produces and outputs a digital data representation of the operational status of the input device 114 based on input status signals received from the input device 114 and communicates the digital data representation to the processor module 117.

In contrast to the known I/O module 118 which includes at least one CJC sensor 150 embedded in or otherwise connected to the removable terminal block 118R, an I/O module 218 provided in accordance with the present development includes one or more CJC sensors 250 operably connected to the printed circuit board assembly 218P of the I/O module base 218B and thermally associated with one or more of the second constituent contacts CXnb′ (i.e., CX1b′, CX2b′, . . . ) to sense the temperature of the second constituent contact(s) CXnb′. The CJC sensor(s) 250 can be physically connected to or abutted with one or more of the second constituent contact(s) CXnb′ such as by a thermally conductive adhesive or otherwise physically connected to, abutted with, or otherwise thermally associated with one or more of the second constituent contact(s) CXnb′ such that the one or more second constituent contacts CXnb′ conduct heat directly into the CJC sensor 250. In another example, the CJC sensor 250 is not physically connected to or abutted with the second constituent contact(s) CXnb′ but is instead electrically connected to one or more of the terminals T such as by being electrically connected to the terminal T or its first constituent contact CXna′ or its corresponding second constituent contact CXnb′ by a copper or other electrically conductive metallic connection such as a contact, wire and/or trace as illustrated by the broken line EX in FIG. 5 such that the electrical connection EX provides a thermal pathway for heat from the terminal T and from the corresponding first and second constituent contacts CXna′, CXnb′ to be conducted into the CJC sensor 250 through the electrical connection EX. The electrical connection EX can be electrically connected to either one of the sensor conductors or leads S1,S2 of the CJC sensor 250 that operatively connect the CJC sensor 250 to the I/O circuitry 218C. As such, each CJC sensor 250 is thermally associated with one or more of the second constituent contacts CXnb′ (and thus also thermally associated with the corresponding first constituent contact CXna′ and the corresponding terminal T) to sense the temperature of the first constituent contact CXna′, the second constituent contact CXnb′, and the corresponding terminal T. Each CJC sensor 250 can be a thermistor or other temperature sensor. In this manner, the CJC sensor 250 senses the temperature of the second constituent contact(s) CXnb′ with which it is operably associated and provides and outputs an output signal that represents the temperature of the second constituent contact(s) CXnb′. The temperature value output by the CJC sensor 250 is used as a cold junction compensation value for cold junction compensation for a thermocouple TC that includes first and second conductors TC1,TC2 connected respectively to first and second terminals T of the removable terminal block 218R, wherein at least one and preferably both thermocouple conductors TC1,TC2 are connected to a terminal T that is associated with a CJC sensor 250, i.e., at least one and preferably both thermocouple conductors TC1, TC2 are connected to a terminal T that is electrically connected to a respective second contact constituent CXnb′ associated with a CJC sensor 250 that senses the temperature of the respective second constituent contact CXnb′ which approximates the temperature of the RTB terminal T to which the thermocouple conductor TC1,TC2 is connected. The temperature sensed by the CJC sensor 250 will approximate the actual temperature of the corresponding RTB terminal T that is electrically connected to the second contact constituent CXnb′ that is associated with the CJC sensor 250. When the removable terminal block 218R is operably connected to the I/O module base 218B, the temperature sensed by each CJC sensor 250 will be the same as or at least closely approximate the temperature of the removable terminal block terminal T connected to the corresponding first constituent contact CXna′ of the mated contact pair CXn′ (CXna′,CXnb′). Each CJC sensor 250 can comprise a thermistor temperature sensor including first and second conductors S1,S2 that are operably connected to the I/O circuit 218C through the printed circuit board assembly 218P, independent of said plurality of contact pairs CXn′, i.e., the first and second CJC sensor conductors S1,S2 do not utilize or require a contact pair CXn′ to electrically connect to the I/O circuitry 218C of the I/O base 218B. Unlike the I/O module 118, each CJC sensor 250 remains within and physically connected to the I/O module base 218B when the RTB 218R is physically separated from the I/O module base 218B.

As is also shown in FIG. 5, an I/O module 218 provided in accordance with an embodiment of the present development can include multiple CJC sensors 250 connected to the printed circuit board assembly 218P of the I/O module base 218B, wherein each CJC sensor comprises a thermistor or other temperature sensor operatively associated with one or more of the second constituent contacts CXnb′ of the terminal block contact pairs CXn′ for sensing the temperature of the second constituent contact(s) CXnb′ wherein the sensed temperature by each CJC sensor 250 is used as a cold junction compensation value for a thermocouple TC connected to the corresponding RTB terminal T that is electrically connected with the second constituent contact CXnb′ associated with the CJC sensor 250. FIG. 5 also shows that a single CJC sensor 250 connected to the printed circuit board assembly 218P can be operatively associated with more than one second constituent contact CXnb′ for sensing the temperature of the multiple second constituent contacts CXnb.

Those of ordinary skill in the art will recognize that, unlike a known I/O module 118 of FIGS. 1-4, the CJC sensor 250 (or each CJC sensor 250) of the present I/O module 218 is (arc) always physically connected to said I/O module base 218B and always operatively connected to the I/O circuitry 218C of the printed circuit board assembly 218P for all positions of the removable terminal block 218R, i.e., both when the RTB 218R is physically connected to the I/O module base 218B and also when the RTB 218R is physically separated from the I/O module base 218B.

As discussed above, the embodiment of the present invention discussed in FIG. 5, provides a CJC sensor 250 in the base 218B of the I/O module 218 such that the CJC sensor 250 is continually connected to the I/O circuitry 218C and does not require contact pairs CXn to transfer a feedback signal from the CJC sensor 250 to the I/O circuitry 218C. However, mounting the CJC sensor 250 proximate the second contact CXnb′ of a contact pair CXn places the CJC sensor some distance from the terminal T of the RTB 218R. Although the temperature present at the contact pair CXn will be close to the temperature present at the terminals T of the RTB 218R, there will be some differential. In some applications, it may be desirable to obtain the temperature at the terminal T of the RTB 218R in order to obtain a more precise reading of the process temperature being measured by the thermocouple TC.

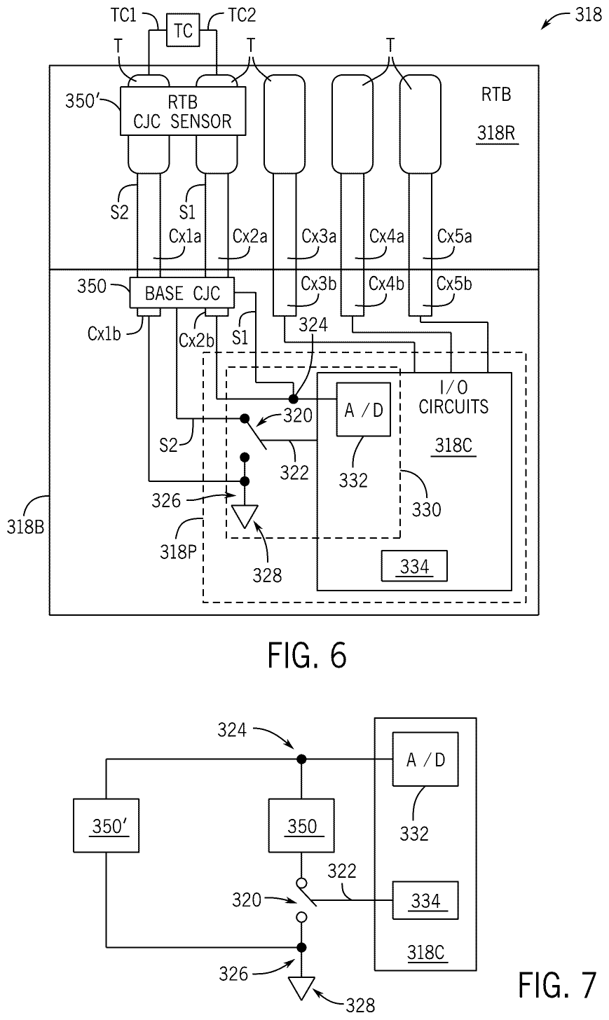

Turning next to FIGS. 6 and 7, it is another feature of the present invention that a single I/O base 318B may receive either an RTB without a CJC sensor or an RTB 318R with a CJC sensor 350′ mounted therein. When one or more CJC sensors 350′ are embedded in the body of the RTB 318R, first and second conductors S1,S2 of the CJC sensor 350 are electrically connected to the I/O circuitry 318C of the I/O module base 318B respectively through a first contact pair CX1 (for the first CJC sensor conductor S1) and a second contact pair CX2 (for the second CJC sensor conductor S2). The first constituent contact CX1a, CX2a of each of contact pair CX1, CX2 is operably connected to one of the sensor conductors S1, S2 within the removable terminal block 318R, and the second constituent contact CX1b, CX2b of each of the first and second contact pairs CX1, CX2 is connected to the I/O module base printed circuit board 318P and operably connected to the I/O circuitry 318C.

When an RTB 318R with a CJC sensor 350′ is mounted to an I/O module base 318B which also includes a CJC sensor 350, both sensors generate feedback signals which may be utilized by the I/O circuitry 318C. Each of the CJC sensors 350, 350′ include conductors S1, S2 by which the corresponding feedback signal is provided to the I/O circuitry 318C. Each of the first conductors SI are electrically connected to first junction 324 on the printed circuit board 318P, and each of the second conductors S2 are either continually or selectively connected to second junction 326 on the printed circuit board 318P. The second junction 326 is also connected to an electrical ground connection 328. Thus, the first conductors SI are utilized to conduct the feedback signals from each CJC sensor 350, 350′, and the second conductors S2 are ground conductors for each CJC sensor.

A switch 320 is provided which selectively connects the first CJC sensor 350 to the electrical ground connection 328. The switch 320 is connected in series with the first CJC sensor 350 and an electrical ground connection 328. The controller 334 in the I/O circuit 318C generates a control signal 322 to control operation of the switch 320. When the control signal 322 is in a first state, the switch 320 is open, disconnecting the switch 320 from the electrical ground connection 328. When the control signal 322 is in a second state, the switch 320 is closed, connecting the switch 320 to the electrical ground connection 328. The switch 320 may be, for example, a transistor where closing the switch 320 means setting voltages at each terminal of the transistor to establish an electrical conduction path through the transistor and opening the switch 320 means setting voltages at each terminal of the transistor to prevent conduction through the transistor. When the switch is closed, the first CJC sensor 350 is operatively connected between the electrical ground connection 328 and an input terminal for an analog-to-digital (A/D) converter 332. When the switch is open, the first CJC sensor 350 is not operational and, absent the presence of a second CJC sensor 350′, a high impedance state exists at the input terminal of the A/D converter 332. Therefore, if an RTB with no CJC sensor 350′ is connected to the base 318B, the A/D converter will detect a first value corresponding to the first CJC sensor 350 being present at the input terminal when the switch 320 is closed, and the A/D converter will detect a high-impedance state corresponding to no CJC sensor being present at the input terminal when the switch 320 is open.

In contrast, when an RTB 318R with a CJC sensor 350′ is connected to the base 318B, the A/D converter will detect two different values at the input terminal. The CJC sensor 350′ in the RTB 318R is connected in parallel to the CJC sensor 350 in the base 318B. By controlling operation of the switch 320, the I/O circuit can detect two different values present at the input terminal of the A/D converter 332. When the switch is open, the first CJC sensor 350 is not operational and, therefore, the second CJC sensor 350′ is the only sensor being detected at the input terminal of the A/D converter 332. The A/D converter will detect a second value corresponding to the presence of the second CJC sensor 350′. When the switch is closed, the first CJC sensor 350 is operatively connected in parallel with the second CJC sensor 350′ and, therefore, the input terminal of the A/D converter 332 detects a combination of the first and second CJC sensors. The A/D converter will detect a third value corresponding to this combination of the first and second CJC sensors being present at the input terminal when the switch 320 is closed and the RTB 318R includes an embedded CJC sensor 350′.

As previously indicated, the present invention contemplates that a single I/O base 318B may receive either an RTB without a CJC sensor or an RTB 318R with a CJC sensor 350′ mounted therein. The I/O base 318B represents a greater percentage of the cost for an I/O module 318 than the RTB. By allowing a single I/O base 318B to accommodate different RTBs, stocking of components for maintenance purposes is simplified. A supply of one base 318B may be stocked for use in multiple applications. Individual RTBs may be stocked according to the utilization of each RTB in an industrial control environment.

In order to identify which RTB has been connected to the I/O base 318B, the I/O base 318B is configured to execute an automatic detection process for identifying which CJC sensor, or sensors, are connected to the I/O base 318B. According to one aspect of the invention, the automatic detection process may be executed upon power-up of the I/O module 318. In an initial detection state, the controller 334 disables the control signal 322 to the switch 320, causing the switch to open and disconnecting the base CJC sensor 350 from the electrical ground connection 328. The controller 334 then reads the value at the input of the A/D converter 332. If a high impedance state is present at the input of the A/D converter 332, then no RTB CJC censor 350′ is present. If, however, the A/D converter 332 detects the second value corresponding to the presence of the second CJC sensor 350′, the controller 334 determines that the second CJC sensor 350′ is present and will utilize the second CJC sensor 350′ to compensate the value of a thermocouple, TC, present at the terminals, T, of the RTB 318R.

If the A/D converter 332 detects the high impedance state with the control signal 322 disabled, the controller 334 then enables the control signal 322 to close the switch 320, connecting the base CJC sensor 350 to the electrical ground connection 328. With no RTB CJC sensor 350′ present and with the base CJC sensor 350 connected, the A/D converter 332 should now detect the first value corresponding to the first CJC sensor 350 being present. However, the absence of the RTB CJC sensor 350′ may be caused by the RTB 318R being removed from the base 318B. Therefore, the controller 334, upon confirming the first value present at the input of the A/D converter 332, conducts an additional test for the presence of the RTB 318R on the base 318B of the I/O module 318. The controller 334 is configured to receive input signals from each terminal T of the RTB 318R. If the RTB 318R is disconnected from the base 318B, each channel of the RTB 318R will appear as an open circuit to the controller 334. If the controller 334 detects all channels being open, then the controller 334 determines that the RTB 318R is removed and returns back to monitoring the value at the input of the A/D converter 332.

The controller 334 will continue monitoring the value of the A/D converter 332 until the RTB 318R is again connected to the base 318B. Because the switch 320 is closed and the base CJC sensor 350 is connected to the electrical ground connection 328, if an RTB CJC Sensor 350′ is also present, the A/D converter 332 will now detect the third value corresponding to the combination of the first and second CJC sensors being present at the input terminal of the A/D converter 332. If the RTB CJC Sensor 350′ is not present while the switch 320 is closed and the RTB 318R is present on the base, the A/D converter 332 will detect the first value corresponding to just the first CJC sensor 350 being present. Because the controller 334 now determines that the RTB 318R is present, the controller 334 may complete the auto-detect routine, having determined whether an RTB CJC sensor 350′ is present on the I/O module 318.

According to another aspect of the invention, the controller 334 may further execute to disable the switch 320 when the RTB CJC sensor 350′ is detected. Upon completion of the auto detection routine, if the controller 334 has detected the RTB CJC sensor 350′ the controller 334 utilizes the removable CJC sensor 350′ by setting the signal 322 to the switch 320 to disconnect the first CJC sensor 350 onboard the base 318B from the electrical ground connection 328, thereby disabling the sensor.

According to still another feature of the invention, the controller 334 may be configured to execute the automatic detection process for identifying which CJC sensor, or sensors, are connected to the I/O base 318B any time the RTB 318R is removed from the base 318B. As indicated above, the controller 334 is able to detect when the RTB 318R is disconnected from the base 318B. The potential exists that an initial RTB 318R may have been connected to the base 318B which did not include a second CJC sensor 350′. During maintenance or during an upgrade, for example, a technician may replace the original RTB 318R with an RTB 318R that does include the second CJC sensor 350′ Therefore, after first detecting that the RTB 318R has been removed, when the controller 334 again detects the presence of the RTB 318R the controller 334 may initiate the steps of the autodetection routine, as discussed above, to determine if the RTB 318R which is reconnected to the base 318B includes a CJC sensor 350′.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. An Input/Output (I/O) module, comprising:
a base;
a removable terminal block (RTB) selectively connected to the base, wherein the RTB includes a plurality of terminals;
an I/O circuit mounted within the base;
a plurality of contact pairs, wherein:
each contact pair includes a first contact mounted in the RTB and electrically connected to one of the plurality of terminals,
each contact pair includes a second contact mounted in the base and electrically connected to the I/O circuit;
a first cold junction compensation (CJC) sensor mounted within the base proximate the second contact from one of the plurality of contact pairs and operative to generate a first feedback signal corresponding to a temperature present at the second contact; and
a switch connected between the first CJC sensor and an electrical ground connection, wherein the switch selectively connects the first CJC sensor to the electrical ground connection.

2. The I/O module of claim 1, further comprising a controller operative to generate a control signal for the switch to selectively connect the first CJC sensor to the electrical ground connection.

3. The I/O module of claim 2, wherein:
the I/O circuit further comprises an analog-to digital (A/D) converter operatively connected to receive the first feedback signal, and
the controller is further operative to:
set the control signal to close the switch and to connect the first CJC sensor to the electrical ground connection, and
detect a first value from the A/D converter corresponding to the first feedback signal when the first CJC sensor is connected to the electrical ground connection.

4. The I/O module of claim 3, wherein the RTB further comprises:
at least one terminal designated as a temperature sensor terminal; and
a second CJC sensor mounted within the RTB proximate the at least one terminal designated as the temperature sensor terminal and operative to generate a second feedback signal corresponding to a temperature present at the at least one terminal.

5. The I/O module of claim 4, wherein at least one of the plurality of contact pairs is electrically connected to conduct the second feedback signal between the second CJC sensor and the A/D converter.

6. The I/O module of claim 4, wherein the controller is further operative to:
set the control signal to disconnect the switch from the electrical ground connection,
detect a second value from the A/D converter corresponding to the second feedback signal when the switch is disconnected from the electrical ground connection,
set the control signal to connect the switch to the electrical ground connection, and
detect a third value from the A/D converter corresponding to a combination of the first feedback signal and the second feedback signal.

7. The I/O module of claim 3, further comprising a thermocouple operatively connected to a first terminal and a second terminal of the RTB, wherein the thermocouple generates a temperature feedback signal.

8. The I/O module of claim 7, wherein the I/O circuit is further operative to compensate the temperature feedback signal by the first feedback signal.

9. The I/O module of claim 7, further comprising an electrically conductive metallic connection between one of the contact pairs and the first CJC sensor, wherein the electrically conductive metallic connection also defines, at least in part, a thermal conduction path from the corresponding terminal to the first CJC sensor, and wherein the first feedback signal corresponds to a temperature present on the electrically conductive metallic connection.

10. An I/O module, comprising:
a base configured to selectively receive either a first removable terminal block (RTB) or a second RTB;
an I/O circuit mounted within the base;
a plurality of first contacts mounted within the base and electrically connected to the I/O circuit;
a first cold junction compensation (CJC) sensor mounted within the base proximate one of the plurality of first contacts and operative to generate a first feedback signal corresponding to a temperature present at the corresponding first contact;
a controller in the I/O circuit operative to generate a control signal to selectively connect the first CJC sensor to an electrical ground connection; and
a switch connected between the first CJC sensor and the electrical ground connection, wherein the switch receives the control signal to selectively connect the first CJC sensor to the electrical ground connection.

11. The I/O module of claim 10 further comprising the first RTB selectively connected to the base, wherein the first RTB includes:
a plurality of terminals; and
a plurality of second contacts, wherein each of the plurality of first contacts corresponds to one of the plurality of second contacts to define a contact pair and wherein each of the plurality of second contacts is electrically connected to one of the plurality of terminals.

12. The I/O module of claim 11, wherein:
the I/O circuit further comprises an analog-to digital (A/D) converter operatively connected to receive the first feedback signal;
the controller is further operative to set the control signal to close the switch and connect the first CJC sensor to the electrical ground connection; and
the controller is further operative to detect a first value from the A/D converter corresponding to the first feedback signal when the first CJC sensor is connected to the electrical ground connection.

13. The I/O module of claim 12, further comprising a thermocouple operatively connected to a first terminal and a second terminal of the RTB, wherein:
the thermocouple generates a temperature feedback signal, and
the I/O circuit is further operative to compensate the temperature feedback signal by the first feedback signal.

14. The I/O module of claim 10, further comprising the second RTB selectively connected to the base, wherein the second RTB includes:
a plurality of terminals, wherein at least one terminal is designated as a temperature sensor terminal;
a second CJC sensor mounted within the second RTB proximate the at least one terminal designated as the temperature sensor terminal and operative to generate a second feedback signal corresponding to a temperature present at the at least one terminal; and
a plurality of second contacts, wherein each of the plurality of first contacts corresponds to one of the plurality of second contacts to define a contact pair and wherein each of the plurality of second contacts is electrically connected to one of the plurality of terminals.

15. The I/O module of claim 14, wherein
the I/O circuit further comprises an analog-to digital (A/D) converter operatively connected to receive the first feedback signal and the second feedback signal; and
the controller is further operative to:
set the control signal to open the switch and disconnect the first CJC sensor from the electrical ground connection,
detect a second value from the A/D converter corresponding to the second feedback signal when the first CJC sensor is disconnected from the electrical ground connection,
set the control signal to close the switch and connect the first CJC sensor to the electrical ground connection, and
detect a third value from the A/D converter corresponding to a combination of the first feedback signal and the second feedback signal when the first CJC sensor is connected to the electrical ground connection.

16. The I/O module of claim 15, further comprising a thermocouple operatively connected to a first terminal and a second terminal of the RTB, wherein:
the thermocouple generates a temperature feedback signal, and
the I/O circuit is further operative to compensate the temperature feedback signal by the second feedback signal.

17. A method of detecting a cold junction compensation (CJC) sensor in an Input/Output (I/O) module, the method comprising the steps of:
providing a first cold junction compensation (CJC) sensor proximate a second contact from a contact pair, wherein:
a first contact of the contact pair is mounted in a removable terminal block (RTB) for the I/O module,
the first contact is electrically connected to a terminal for the RTB,
the second contact is mounted in a base for the I/O module, and
the second contact is electrically connected to an I/O circuit mounted in the base;
generating a first feedback signal with the first CJC, wherein the first feedback signal corresponds to a temperature present at the second contact;
selectively connecting the first CJC to an electrical ground connection with a switch; and
detecting a first value of the first feedback signal with an analog-to digital (A/D) converter, wherein the first value corresponds to the first CJC present in the base of the I/O module and the switch closed to connect the first CJC to the electrical ground connection.

18. The method of claim 17 further comprising the step of generating a control signal for the switch to selectively connect the first CJC sensor to the electrical ground connection with a controller in the I/O circuit.

19. The method of claim 18 further comprising the step of detecting a second value with the A/D converter, wherein:
the second value corresponds to a second CJC present in the RTB proximate at least one terminal designated as a temperature sensor terminal,
the second CJC is operative to generate a second feedback signal corresponding to a temperature present at the at least one terminal, and
the second value is detected with the switch open to selectively disconnect the first CJC sensor from the electrical ground connection.

20. The method of claim 19 further comprising the step of detecting a third value with the A/D converter, wherein:
the third value corresponds to a combination of the first feedback signal and the second feedback signal, and
the third value is detected when the switch closed to selectively connect the first CJC sensor to the electrical ground connection and when the second CJC is present in the RTB.
